(19) United States
(12) Patent Application Publication
(10) Pub. No.: US 2006/0279689 A1
(43) Pub. Date: Dec. 14, 2006

(54) Method for ejecting liquid, liquid ejection apparatus, and method for manufacturing electro-optic panel

(76) Inventors: Tamotsu Goto, Chino-shi (JP); Osamu Kasuga, Suwa-shi (JP)

Correspondence Address: HARNESS, DICKEY & PIERCE, P.L.C., P.O. BOX 828, BLOOMFIELD HILLS, MI, 48303, US

(21) Appl. No.: 11/434,547

(22) Filed: May 15, 2006

(30) Foreign Application Priority Data
May 16, 2005 (JP) 2005-142193

(51) Int. Cl. G02F 1/1341

(52) U.S. Cl. 349/189

(57) ABSTRACT

A plurality of element substrates are defined on a glass wafer. A seal portion containing a spacer is defined on a peripheral portion of each of the element substrates. A width measurement portion measures the width of each of the seal portions. A liquid ejecting portion ejects a droplet of liquid crystal onto a liquid crystal seal section encompassed by each seal portion by the amount corresponding to the width. This provides uniform distances between the element substrates and the associated color filter substrates.

### CROSS-REFERENCE TO RELATED APPLICATION

This application is based upon and claims the benefit of priority from prior Japanese Patent Application No. 2005-142193, filed on May 16, 2005, the entire contents of which are incorporated herein by reference.

### BACKGROUND OF THE INVENTION

The present invention relates to a method for ejecting liquid, a liquid ejection apparatus, and a method for manufacturing electro-optic panels.

As a typical method for manufacturing a liquid crystal panel, a liquid crystal dripping method is known. For example, in a method described in Japanese Laid-Open Patent Publication No. 2001-330840, sealing agent is applied onto a peripheral portion of one of a pair of glass substrates. A liquid crystal dripping section is thus defined by the space encompassed by the seal agent. Liquid crystal is then dripped onto the liquid crystal dripping section by means of a dispenser (the liquid crystal dripping method). Subsequently, the two glass substrates are bonded together through the seal agent, thus providing a liquid crystal panel. However, typical accuracy for dripping liquid crystal by this method has been only ±3 percent. The liquid crystal dripping method has thus been inapplicable particularly to the manufacture of smaller-sized liquid crystal panels in which the distance between two opposing glass substrates may greatly vary from product to product. Nonetheless, through improvement of dispensers or involvement of an inkjet method, the liquid crystal dripping method is now more available for the manufacture of the smaller-sized liquid crystal panels.

However, in further smaller liquid crystal panels like those used in projectors, the surface area of a liquid crystal dripping section becomes correspondingly smaller. Therefore, product-to-product variation of the surface area of the liquid crystal dripping section, which is influenced by corresponding variation of the width of seal agent applied on a substrate, cannot be ignored. Specifically, such variation of the surface area of the liquid crystal dripping portion causes corresponding product-to-product variation of the height of liquid crystal applied onto the liquid crystal dripping section. This correspondingly varies the distance between two glass substrates in different products.

### SUMMARY

Accordingly, it is an objective of the present invention to provide a method for ejecting liquid, a liquid ejection apparatus, and a method for manufacturing an electro-optic panel that ensure a uniform distance between a pair of substrates, which seal liquid crystal, in different products.

According to one aspect of the invention, method for ejecting liquid in which a droplet of the liquid is ejected onto a liquid seal section encompassed by a seal portion defined on a substrate is provided. The method includes a volume measurement step of measuring the volume of the liquid seal section. The method further includes a determination step of determining the ejection amount of the droplet ejected onto the liquid seal section in correspondence with a measurement of the volume; and an ejection step of ejecting the droplet onto the liquid seal section by the determined ejection amount.

According to another aspect of the invention, a liquid ejection apparatus that ejects a droplet of liquid onto a liquid seal section encompassed by a seal portion defined on a substrate is provided. The apparatus includes a volume measurement portion that measures the volume of the liquid seal section. A determining portion determines the ejection amount of the droplet ejected onto the liquid seal section in correspondence with a measurement of the volume. An ejecting portion ejects the droplet onto the liquid seal section by the determined ejection amount.

According to another aspect of the invention, a method for manufacturing an electro-optic panel by ejecting a droplet of liquid formed of an optical material to a substrate is provided. The method includes a seal portion formation step of defining a seal portion on the substrate for forming a liquid seal section encompassed by the seal portion. The method further includes a volume measurement step of measuring the volume of the liquid seal section; a determination step of determining the ejection amount of the droplet ejected onto the liquid seal section in correspondence with a measurement of the volume. The method further includes an ejection step of ejecting the droplet onto the liquid seal section by the ejection amount.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing a liquid crystal panel manufactured by a liquid ejection apparatus of FIG. 3;

FIG. 2 is a plan view showing a glass wafer from which a plurality of element substrates of FIG. 1 are obtained;

FIG. 3 is a front view schematically showing a liquid ejection apparatus according to an embodiment of the present invention;

FIG. 4 is a plan view schematically showing the liquid ejection apparatus of FIG. 3;

FIG. 5 is an enlarged view showing a width measurement portion and a liquid ejecting portion of FIG. 3; and

FIG. 6 is an electric block diagram showing the electric configuration of the liquid ejection apparatus of FIG. 3.

### DETAILED DESCRIPTION OF THE PREFERRED EMBODIMENTS

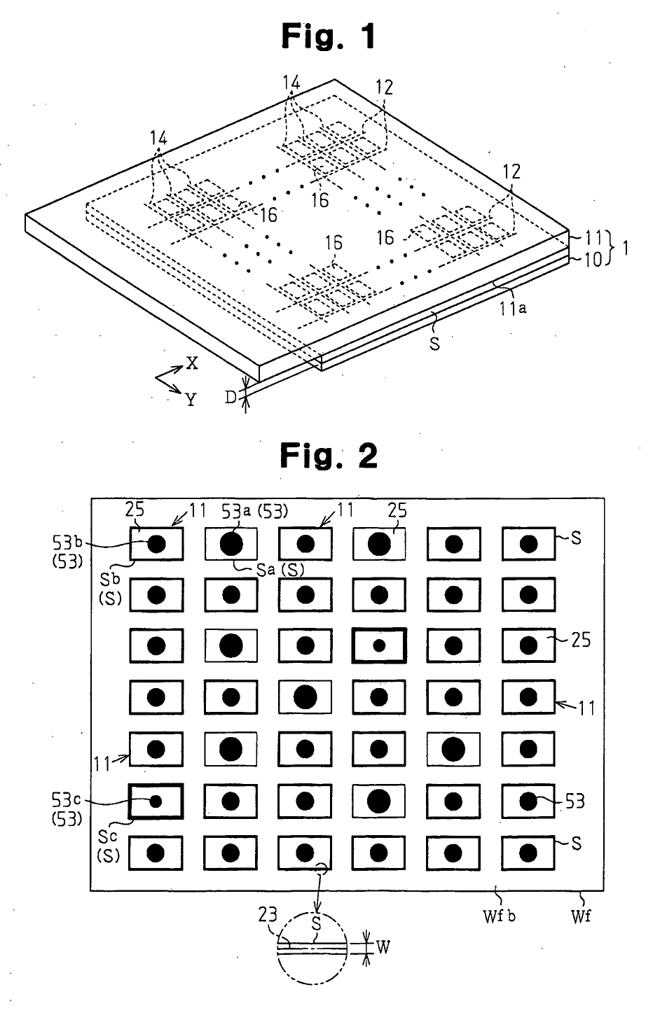

An embodiment of the present invention will now be described with reference to FIGS. 1 to 6.

First, a liquid crystal panel manufactured by a liquid ejection apparatus according to the present invention will be explained.

As shown in FIG. 1, a liquid crystal panel 1, or an electro-optic panel, includes a color filter substrate 10 and an element substrate 11 that opposes the color filter substrate 10. The element substrate 11 has an element forming surface 11a that opposes the color filter substrate 10. The element forming surface 11a receives a droplet of liquid containing liquid crystal molecules, which are not illustrated. The liquid crystal panel 1 is formed by bonding the color filter substrate 10 and the element substrate 11 together through a seal portion S as spaced from each other at a predetermined distance D. The element substrate 11 is defined by a rectangular non-alkaline glass substrate. A plurality of scanning lines 12 are defined on the element forming surface 11a and spaced at predetermined distances, extending in direction X. Each of the scanning lines 12 is electrically connected to a non-illustrated scanning line driver circuit, which is provided at an end of the element substrate 11. In response to a scanning control signal generated by a non-illustrated control circuit, the scanning line driver circuit selectively drives a predetermined one of the scanning lines 12 at a predetermined timing, or sends a scanning signal to the selected scanning line 12.

A plurality of data lines 14 are defined also on the element forming surface 11a and spaced at predetermined distances, extending in direction Y. Each of the data lines 14 is electrically connected to a non-illustrated data line driver circuit, which is provided on a side of the element substrate 11. In correspondence with display data provided by a non-illustrated external device, the data line driver circuit generates a data signal and sends the signal to the corresponding one of the data lines 14 at a predetermined timing.

A plurality of pixel areas 16 are each provided in the space defined by the corresponding one of the scanning lines 12 and the associated one of the data lines 14. Each of the pixel areas 16 is connected to the corresponding scanning line 12 and the associated data line 14. The pixel areas 16 are arranged in a matrix-like shape of “I” lines by “j” rows. Each pixel area 16 includes a non-illustrated control element formed of TFT and a pixel electrode defined by a transparent conductive film of ITO. In other words, in the illustrated embodiment, the liquid crystal panel 1 is an active matrix type liquid crystal panel including a TFT as a control element. A non-illustrated alignment film is formed above the scanning lines 12, the data lines 14, and the pixel areas 16 and on the entire element forming surface 11a. An alignment process such as rubbing is performed on the alignment film in such a manner as to allow the alignment film to align the liquid crystal molecules.

As the scanning line driver circuit sequentially selects the scanning lines 12 one by one in accordance with the line progressive scan, the control elements of the corresponding pixel areas 16 are held in an ON state for an instructed period. When one of the control elements is turned on, the data signal generated by the data line driver circuit is sent to the pixel electrode through the data lines 14 and the control element. Thus, in correspondence with the difference between the potential of the non-illustrated pixel electrode of the element substrate 11 and the potential of a non-illustrated opposing electrode of the color filter substrate 10, the alignment state of the liquid crystal molecules is set in such a manner as to modulate reflected light of light transmitted from a non-illustrated illumination device or an external source. Accordingly, through selective transmission of the modulated light through a non-illustrated polarization plate, a desired full-color image is displayed on the liquid crystal panel 1 through the color filter substrate 10.

As illustrated in FIG. 2, a plurality of element substrates 11 are formed on a glass wafer Wf and spaced from adjacent ones at equal distances. A non-illustrated scrub line is defined between an adjacent pair of the element substrates 11. The glass wafer Wf is thus cut apart along the scrub lines in such a manner that the multiple element substrates 11 are obtained from the single glass wafer Wf. Similarly, a plurality of color filter substrates 10 are defined on a non-illustrated, separate glass wafer. The glass wafer is also cut apart along scrub lines in such a manner that the multiple color filter substrates 10 are produced from the single glass wafer.

A seal agent is applied onto a peripheral portion of the element forming surface 11a of each element substrate 11 by means of a non-illustrated dispenser, thus defining the seal portion S. In the illustrated embodiment, the seal agent is formed by, for example, ultraviolet curing resin and includes a spacer 21 (see FIG. 5). The color filter substrate 10 and the element substrate 11 are bonded together through the seal portion S and spaced from each other by the spacer 21 at a predetermined distance D. The width W of the seal portion S is varied from one element substrate 11 to another, which are formed from the glass wafer Wf, in correspondence with pressure caused by application of the seal agent. For example, the width W of a first seal portion Sa is smaller than a predetermined reference width, while the width W of a second seal portion Sb coincides with the reference width. The width W of a third seal portion Sc is greater than the reference width.

An intermediate portion 23 of each seal portion S is located at a predetermined position, which is set before application of the seal agent. A liquid crystal seal section 25, or a liquid seal section, is defined in the space encompassed by each seal portion S. The surface area (the volume) of the liquid crystal seal section 25 is varied from one element substrate 11 to another in correspondence with the width W of the associated seal portion S. In other words, in a seal portion S with a smaller width W, the surface area of the liquid crystal seal section 25 becomes greater than a predetermined reference surface area. In a seal portion S with a greater width W, the surface area of the liquid crystal seal section 25 becomes smaller than the reference surface area. A liquid ejection apparatus 30 (FIG. 5), which will be explained later, ejects a droplet 53 of liquid crystal into each of the liquid crystal seal sections 25 by the amount corresponding to the surface area of the liquid crystal seal section 25. Specifically, the liquid ejection apparatus 30 ejects a first droplet 53a of a larger ejection amount onto a liquid crystal seal section 25 with a surface area greater than the reference surface area. A second droplet 53b of a standard ejection amount is ejected onto a liquid crystal seal section 25 with a surface area coinciding with the reference surface area. A third droplet 53c of a smaller ejection amount is ejected onto a liquid crystal seal section 25 with a surface area smaller than the reference surface area.

The liquid ejection apparatus 30, which ejects the droplets 53 onto the liquid crystal seal sections 25, will hereafter be described.

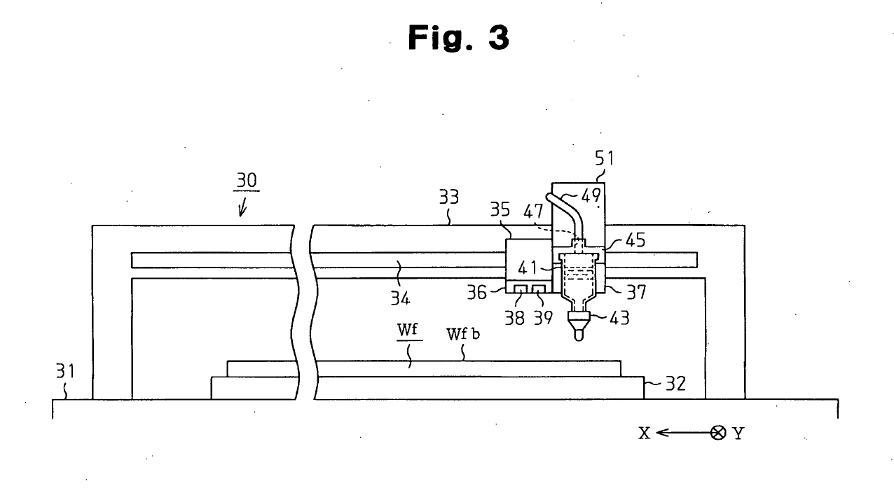

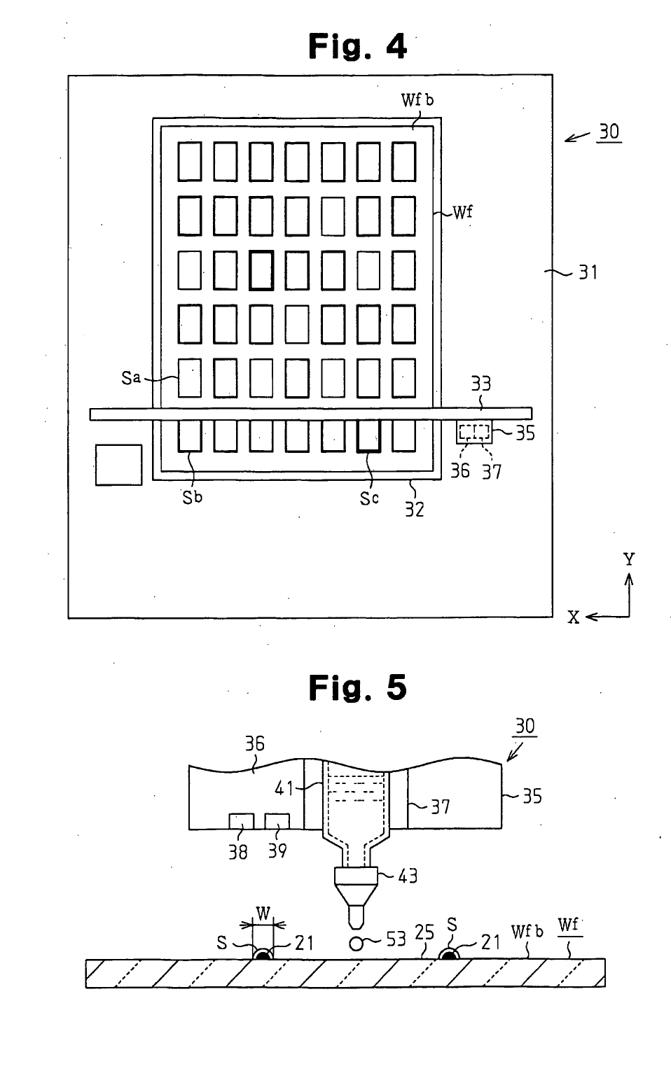

As shown in FIGS. 3 and 4, the liquid ejection apparatus 30 includes a support table 31. A transport table 32 is formed on the support table 31. The transport table 32 is reciprocated by a non-illustrated Y-axis driver mechanism, which is provided on the support table 31, in direction Y.

The glass wafer Wf is mounted on the transport table 32 with a backside Wfb of the glass wafer Wf (the element forming surface 11a of the element substrate 11) facing upward. The glass wafer Wf is thus reciprocated in direction Y. The droplets 53 are each ejected onto the corresponding one of the liquid crystal seal sections 25 (see FIG. 2), which are formed on the backside Wfb of the glass wafer Wf.

A gate-like support frame 33 projects from the support table 31 in a manner straddling the transport table 32. The support frame 33 extends in direction X and is supported by the support table 31. A guide rail 34 is provided in the support frame 33, extending in direction X.

A carriage 35 is slidably supported by the guide rail 34. The carriage 35 is driven by the X-axis driver mechanism to reciprocate along the guide rail 34 at a predetermined speed (the transport speed V). A width measurement portion 36, or a volume measurement portion, and a liquid ejecting portion 37 are formed integrally with each other in the carriage 35.

In the illustrated embodiment, the width measurement portion 36 is defined by a laser sensor and includes a semiconductor laser 38 and a light receiving element 39. The width measurement portion 36 radiates the light of the semiconductor laser 38 onto the glass wafer Wf. The light is then reflected by the glass wafer Wf and received by the light receiving element 39. The width W of the seal portion S is thus measured. In the illustrated embodiment, the width measurement portion 36 measures the width W at the center of the lower side of each element substrate 11 as viewed in FIG. 2.

The liquid ejecting portion 37 of the illustrated embodiment is defined by a dispenser and includes a barrel 41 and a nozzle 43. The barrel 41 retains liquid crystal and the nozzle 43 is removably secured to a distal end of the barrel 41. An upper opening of the barrel 41 is closed by a separable lid 45 in which a supply port 47 for pressurized air is defined. An air supply portion 51 communicates with the supply port 47 through a supply tube 49. Air is drawn through the air supply portion 51 and then sent to the supply port 47 at predetermined timings. The air thus pressurizes the liquid crystal in the barrel 41 and ejects the droplet 53 (see FIG. 5) from a distal opening of the nozzle 43.

The electric configuration of the liquid ejection apparatus 30 will now be explained.

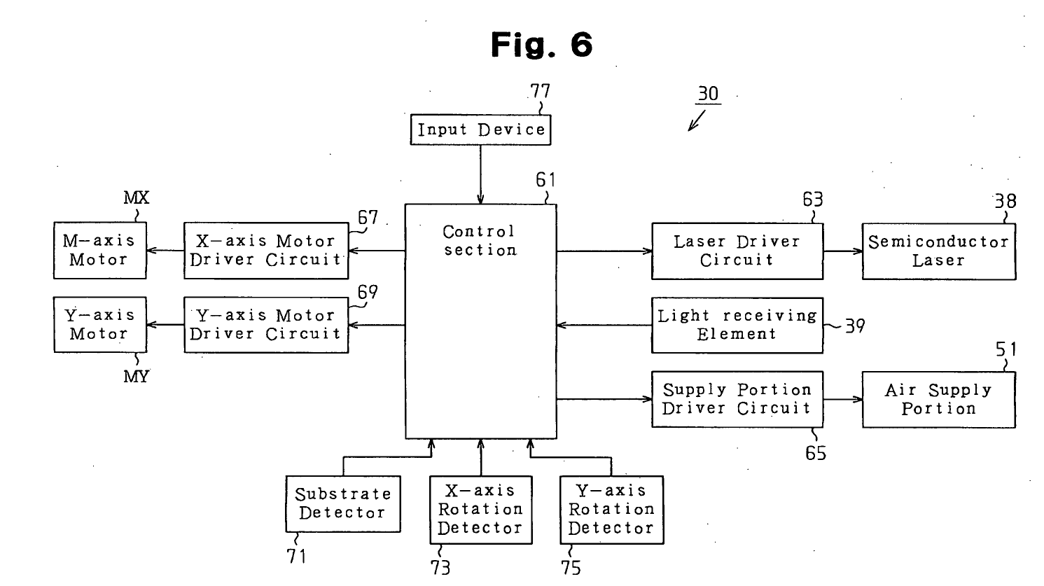

Referring to FIG. 6, a control section 61, or a determining portion, includes a CPU, a RAM, and a ROM. The control section 61 transports the transport table 32 and drives the width measurement portion 36 and the liquid ejecting portion 37 in accordance with different control programs (such as a liquid ejection control program) stored in the ROM or the like.

The ROM stores a first reference value T1 and a second reference value T2, which are reference values in accordance with which the amount of each droplet 53 ejected onto the glass wafer Wf is determined, supply time ST, and the transport speed V. The first reference value T1 is a width in accordance with which it is determined whether the width W of the seal portion S is greater than the reference width, or the ejection amount of the droplet 53 must be decreased. The second reference value T2 (T2<T1) is a width in accordance with which it is determined whether the width W of the seal portion S is smaller than the reference width, or the ejection amount of the droplet 53 must be increased.

The supply time ST is the time for which the pressurized air is continuously supplied to the supply port 47 and memorized in association with the width W of the seal portion S. Specifically, if the width W of the seal portion S is greater than the first reference value T1, the surface area of the liquid crystal seal section 25 is smaller than the reference surface area. In this case, the supply time ST is determined in such a manner that the ejection amount (the weight) of the droplet 53 becomes smaller than a predetermined ejection amount. That is, by shortening the supply time ST with respect to the predetermined time, the time for which the liquid crystal is continuously pressurized is shortened, thus decreasing the ejection amount of the droplet 53. Contrastingly, if the width W of the seal portion S is smaller than the second reference value, the surface area of the liquid crystal seal section 25 is greater than the reference surface area. In this case, the ejection amount of the droplet 53 must be greater than the predetermined ejection amount. That is, the supply time ST is determined in such a manner that, by prolonging the supply time ST with respect to the predetermined time, the pressurization time of the liquid crystal is prolonged to increase the ejection amount of the droplet 53. Further, if the width W of the seal portion S is smaller than the first reference value T1 and greater than the second reference value T2, the supply time ST is determined in such a manner that the ejection amount of the droplet 53 coincides with the predetermined ejection amount.

A laser driver circuit 63 is connected to the control section 61. The control section 61 sends a drive signal to the laser driver circuit 63 at a predetermined timing before ejecting the droplet 53 onto the glass wafer Wf. In response to the drive signal of the control section 61, the laser driver circuit 63 supplies measurement portion drive voltage to the semiconductor laser 38. This causes the semiconductor laser 38 to radiate a laser beam R onto the glass wafer Wf.

The light receiving element 39 receives the laser beam R (reflected light) that has been reflected by the glass wafer Wf. Thus, in correspondence with the intensity of the reflected light, the control section 61 determines whether the portion at which the laser beam R has been reflected corresponds to the glass wafer Wf or any of the seal portions S. If it is detected that such portion corresponds to an end of the seal portion S in a direction crossing the seal portion S (a direction defined by a horizontal width), the control section 61 starts measurement of the time for which the laser beam R is continuously radiated onto the seal portion S (hereinafter, referred to as radiation time RT), using, for example, a crystal stabilization clock. Afterwards, when the opposing end of the seal portion S is detected, the measurement of the radiation time RT is suspended and the obtained radiation time RT is stored in the RAM. The control section 61 computes the width W by calculating a product of the radiation time RT and the transport speed V. The computation result is stored in the RAM.

The control section 61 is connected to a supply portion driver circuit 65 and thus sends a drive signal to the supply portion driver circuit 65. In response to the drive signal of the control section 61, the supply portion driver circuit 65 supplies pressurized air from the air supply portion 51 to the supply port 47. The pressurized air pressurizes the liquid crystal in the barrel 41, thus ejecting the droplet 53 from the distal opening of the nozzle 43 onto the element substrate 11.

The control section 61 is connected to an X-axis motor driver circuit 67 and sends an X-axis motor drive signal to the X-axis motor driver circuit 67. In response to the X-axis motor drive signal of the control section 61, the X-axis motor driver circuit 67 rotates an X-axis motor MX in a forward or reverse direction to reciprocate the width measurement portion 36 and the liquid ejecting portion 37. For example, if the X-axis motor MX rotates in the forward direction, the width measurement portion 36 and the liquid ejecting portion 37 move in direction X. If the X-axis motor MX rotates in the reverse direction, the liquid ejecting portion 37 moves in the direction opposite to direction X.

The control section 61 is connected to a Y-axis motor driver circuit 69 and sends a Y-axis motor drive signal to the Y-axis motor driver circuit 69. In response to the Y-axis motor drive signal of the control section 61, the Y-axis motor driver circuit 69 rotates an Y-axis motor MY in a forward or reverse direction to reciprocate the transport table 32. For example, if the Y-axis motor MY rotates in the forward direction, the transport table 32 moves in direction Y. If the Y-axis motor MY rotates in the reverse direction, the transport table 32 moves in the direction opposite to direction X. Further, a substrate detector 71 is connected to the control section 61. The substrate detector 71 has image acquiring function by which an end of the glass wafer Wf is detected. In correspondence with detection of the substrate detector 71, the control section 61 calculates the position of the glass wafer Wf that is passing immediately below the nozzle 43.

An X-axis rotation detector 73 is connected to and inputs a detection signal to the control section 61. In correspondence with the detection signal of the X-axis rotation detector 73, the control section 61 detects the rotational direction and the rotational amount of the X-axis motor MX. The movement direction and the movement amount of the glass wafer Wf in direction X with respect to the liquid ejecting portion 37 are thus calculated.

A Y-axis rotation detector 75 is connected to and inputs a detection signal to the control section 61. In correspondence with the detection signal of the Y-axis rotation detector 75, the control section 61 detects the rotational direction and the rotational amount of the Y-axis motor MY. The movement direction and the movement amount of the glass wafer Wf in direction Y with respect to the liquid ejecting portion 37 are thus calculated. An input device 77 is connected to the control section 61. The input device 77 includes manipulation switches such as a start switch and a stop switch. When any of these switches is manipulated, the input device 77 sends a manipulation signal to the control section 61.

A method for ejecting the droplets 53 onto the glass wafer Wf using the liquid ejection apparatus 30 will hereafter be explained. In advance, an alignment film is provided on the glass wafer Wf through rubbing. The seal agent is applied onto each of the element substrates 11 by means of a dispenser or the like. The seal agent forms the seal portion S along the peripheral portion of each element substrate 11. Each of the seal portions S defines the liquid crystal seal section 25.

First, as illustrated in FIGS. 3 and 4, the glass wafer Wf is placed on and fixed to the transport table 32 with the backside Wfb facing upward. In this case, although the multiple element substrates 11 are provided on the glass wafer Wf, the support frame 33 is arranged above the element substrate located rearmost in direction Y. The carriage 35 is arranged in such a manner that, when the glass wafer Wf moves in direction X, the centers of the seal portions S, or the liquid crystal seal sections 25, pass immediately below the carriage 35.

In this state, the control section 61 actuates the X-axis motor MX to transport the glass wafer Wf in direction X by means of the transport table 32. Then, in correspondence with the detection signal of the X-axis rotation detector 73, the control section 61 computes whether the glass wafer Wf has been transported to the side of the seal portion S rearmost in direction X of the element substrate 11 located rearmost in direction X and direction Y on the glass wafer Wf. If the determination is positive, the control section 61 measures the width W of the seal portion S while moving the glass wafer Wf in direction X. In the illustrated embodiment, such measurement of the width W of the seal position S corresponds to a volume measurement step. Specifically, the laser beam R is radiated onto the corresponding element substrate 11 (the glass wafer Wf) by the semiconductor laser 38. The laser beam R is then reflected by the element substrate 11 or the seal portion S and received by the light receiving element 39. This causes the control section 61 to calculate the width W of the seal portion S and store the result in the RAM.

The control section 61 then compares the measurement of the width W of the seal portion S with the first and second reference values T1, T2 retrieved from the ROM, which corresponds to a comparison step. Subsequently, the control section 61 reads out the supply time ST corresponding to the result of comparison from the ROM, which corresponds to a determination step and a selection step. In correspondence with the obtained supply time ST, the control section 61 sends a drive signal to the supply portion driver circuit 65. This causes the supply portion driver circuit 65 to continuously supply pressurized air from the air supply portion 51 to the supply port 47 for the supply time ST. The pressurized air thus continuously pressurizes the liquid crystal in the barrel 41 for the supply time ST. In this manner, as illustrated in FIG. 2, the droplet 53 is ejected from the distal opening of the nozzle 43 by the amount corresponding to the measured width W. In other words, if the surface area of the liquid crystal seal section 25 is greater than the reference surface area, the first droplet 53a of the greater ejection amount is ejected. If the surface area of the liquid crystal seal section 25 coincides with the reference surface area, the second droplet 53b of the standard ejection amount is ejected. If the surface area of the liquid crystal seal section 25 is smaller than the reference surface area, the third droplet 53c of the smaller ejection amount is ejected. In the illustrated embodiment, ejection of the droplets 53 by the liquid ejecting portion 37 corresponds to an ejection step.

This prevents, for example, ejection of the second droplet 53b of the standard ejection amount when the surface area of the liquid crystal seal section 25 is smaller than the reference surface area. That is, the height of the liquid crystal seal section 25 is prevented from increasing in an undesired manner, which increases the distance D between the color filter substrate 10 and the element substrate 11. Further, when the surface area of the liquid crystal seal section 25 is greater than the reference surface area, ejection of the second droplet 53b of the standard ejection amount is suppressed, thus preventing the height of the liquid crystal seal section 25 from decreasing in an undesired manner. The distance D between the color filter substrate 10 and the element substrate 11 thus does not decrease. Accordingly, the distance D between the color filter substrate 10 and the element substrate 11 can be maintained constant.

Afterwards, while moving the glass wafer Wf, the control section 61 measures the width W of the seal portion S of each element substrate 11 of every row. The droplets 53 are thus ejected by the amount corresponding to the measurement of the width W. After ejection of the droplets 53 onto all of the element substrates 11 on the glass wafer Wf is completed, the control section 61 operates the Y-axis motor MY to retreat the glass wafer Wf from the position below the liquid ejecting portion 37.

Following the liquid ejection step, an assembly step is performed on the glass wafer Wf. Specifically, in a vacuum cell, the glass wafer Wf on which the color filter substrates 10 are formed is positioned with respect to and spaced from the glass wafer Wf on which the element substrates 11 are defined. The two glass wafers are then pressurized at a predetermined pressure, thus bonding the glass wafers together. After the bonded glass wafers are removed from the vacuum cell and exposed to the atmospheric air, the difference between the pressure between the glass wafers and the pressure outside the glass wafers acts to expand the liquid crystal. The liquid crystal thus fills the vacuumed space between the glass wafers. Subsequently, in order to adjust the distance between the glass wafers to the predetermined distance D, one of the glass wafers is pressed against the other at a predetermined pressure. In this state, ultraviolet is radiated onto the glass wafers using a ultraviolet radiation lamp, thus hardening the seal agent. Then, the scrub lines are provided on one of the glass wafers and the glass wafers are cut apart along the scrub lines. This provides the crystal panels 1 in each of which the liquid crystal is sealed in the liquid crystal seal section 25 between the color filter substrate 10 and the element substrate 11 that are spaced from each other at the predetermined distance D. Accordingly, using the liquid ejection apparatus 30, a method for manufacturing electro-optic panels like the liquid crystal panels 1 by ejecting optical material such as liquid crystal can be performed

The illustrated embodiment has the following advantages.

(1) In the illustrated embodiment, the width measurement portion 36 measures the width W of the seal portion S defined on each of the element substrates 11. The liquid ejecting portion 37 ejects the droplet 53 onto the liquid crystal seal section 25 by the amount corresponding to the measured width W. This suppresses overflow of the droplet 53 from the liquid crystal seal section 25 or formation of an empty section in the liquid crystal seal section 25 due to insufficient ejection of the droplet 53, regardless of change of the width W of the seal portion S, which also changes the surface area of the liquid crystal seal section 25. The distance between the two substrates (10, 11) is thus maintained uniform among different products. Further, the image quality of the liquid crystal panel 1 improves.

(2) In the illustrated embodiment, the seal agent that forms each seal portion S contains the spacer 21. This brings about uniform heights of the liquid crystal seal sections 25. Thus, simply through measurement of the widths W (the surface areas) of the seal portions S, the droplets 53 can be ejected by the amounts corresponding to the volumes of the corresponding liquid crystal seal sections 25. Accordingly, the distance between the two substrates (10, 11) can be maintained uniform in different products by employing the small and simply configured apparatus.

(3) In the illustrated embodiment, the width W of each seal portion S is measured only at the center of the side located rearmost in direction X. This shortens the time for such measurement and thus the time for manufacturing the liquid crystal panel 1.

(4) In the illustrated embodiment, the width W of each seal portion S is measure by a laser sensor. The laser sensor is relatively small-sized and simply configured and yet capable of accurately measuring the width W.

(5) In the illustrated embodiment, the ejection amount of each droplet 53 is varied by changing the supply time ST. Therefore, by such a simple method, the distance between the two substrates (10, 11) can be maintained uniform in different products.

(6) In the illustrated embodiment, the first reference value T1 and the second reference value T2 are set. Three different ejection amounts of droplets 53 (53a, 53b, 53c) are selected depending on whether the measurement of the width W exceeds the first reference value T1 or the second reference value T2. This shortens the time for determining the ejection amount of the droplet 53 and thus the time for manufacturing the liquid crystal panel 1.

The illustrated embodiment may be modified as follows.

In the illustrated embodiment, the measurement is performed only on the center of the side of each seal portion S located rearmost in direction X. However, the side of each seal portion S located foremost in direction X may be subjected to the measurement. Similarly, the measurement may be performed on the side of each seal portion S located foremost or rearmost in direction Y.

In the illustrated embodiment, the measurement is performed only on the center of the side of each seal portion S located rearmost in direction X. However, the measurement does not necessarily have to be performed on one side but may be carried out on multiple sides of each seal portion S. Further, the measurement may be performed on multiple spots of one of the sides of the seal portion S. This allows further accurate volume measurement of each liquid crystal seal section 25.

In the illustrated embodiment, the first reference value T1 and the second reference value T2 are set. The ejection amount of each droplet 53 for the liquid crystal seal section 25 is selected from the three levels through comparison between the measurement of the width W of the corresponding seal portion S and the first and second reference values T1, T2. Alternatively, only one or three or more reference values may be set and the ejection amount is adjusted in correspondence with these reference values. Further, the ejection amount may be determined directly in correspondence with the width W of each seal portion S, without setting a reference value.

In the illustrated embodiment, the single droplet 53 is ejected onto each of the liquid crystal seal sections 25 by the weight corresponding to the width W of the associated seal portion S. However, the droplets 53 may be ejected by a reduced and constant weight. In this case, the number of ejection cycles changes in correspondence with the width W of each seal portion S. That is, a plurality of droplets 53 are ejected onto each of the liquid crystal seal sections 25.

Although the width W of each seal portion S is measured by the laser sensor, the measurement may be carried out by a sensor such as an optical sensor.

In the illustrated embodiment, the width W of each element substrate 11 is measured separately from those of the other element substrates 11. After each measurement, the droplet 53 is ejected onto the element substrate 11 by the amount corresponding to the measured width W. However, the widths W of all element substrates 11 may be measured continuously. After such continuous measurement, the droplets 53 are ejected onto the element substrates 11 by the amounts corresponding to the widths W of the element substrates 11. In this case, the widths W of the element substrates 11 may be stored in the RAM in such a manner that the amount of the droplet 53 ejected onto each of the element substrates 11 is calculated before the ejection of the droplet 53 onto the element substrate 11. Alternatively, prior to ejection of the droplets 53 onto the element substrates 11, the ejection amounts of the droplets 53 for all of the element substrates 11 may be calculated in advance and stored in the RAM. In this case, the ejection amount of the droplet 53 is retrieved from the RAM before ejection of the droplet 53 onto each one of the element substrates 11. Such ejection is thus performed accordingly. Also, measurement of the width W and ejection of the droplet 53 may be simultaneously performed on all element substrates 11 formed on the glass wafer Wf. Alternatively, such measurement and ejection may be carried out in correspondence with the respective lines or rows of the element substrates 11 defined on the glass wafer Wf.

Although the seal agent of the illustrated embodiment that forms each seal portion S contains the spacer 21, the seal agent does not necessarily have to contain the spacer 21. That is, the spacer 21 may be separately dripped onto each of the element substrates 11.

Although only the width W of each seal portion S is measured in the illustrated embodiment, the height (the thickness) of the seal portion S may be measured. In this case, even if the seal agent does not contain the spacer 21, for example, or the heights of the seal portions S are not constant, the volumes of the liquid crystal seal sections 25 can be measured. Further, if, in a larger-sized element substrate 11, for example, the height of each seal portion S influences change of the volume of the liquid crystal seal section 25 dominantly over the width W of the seal portion S, the volume of the liquid crystal seal section 25 can be measured simply through measurement of the height of each seal portion S.

In the illustrated embodiment, only the width W of each seal portion S is measured. However, both of the width W and the height (the thickness) of the seal portion S may be measured. This allows further accurate measurement of the volumes of the liquid crystal seal sections 25.

Although the liquid ejecting portion 37 is embodied as the dispenser in the illustrated embodiment, an inkjet device may be employed as the liquid ejecting portion 37.

In the illustrated embodiment, the seal portions S are formed using the non-illustrated dispensers. However, the seal portions S may be formed through seal-printing.

In the illustrated embodiment, the seal portion S is formed in each of the element substrates 11. However, the seal portion S may be defined in each of the color filter substrates 10 to form the liquid crystal seal section 25 onto which the droplet 53 is ejected.

In the illustrated embodiment, the present invention is embodied as the liquid ejection apparatus used for manufacturing the liquid crystal panels 1. However, the electro-optic panel manufactured according to the present invention is not restricted to the liquid crystal panel 1 but may be, for example, an organic EL panel. Alternatively, according to the present invention, a field effect type display (an FED or an SED) may be manufactured. This type of display includes a flat electron release element and emits light from a fluorescent substance using electrons released by the element. That is, the droplets 53 ejected by the liquid ejection apparatus do not necessarily have to be formed of liquid crystal but may be organic material forming an organic EL panel or fluorescent material. Alternatively, the present invention may be applied to not only the displays but also other types of electronic devices.

The present examples and embodiments are to be considered as illustrative and not restrictive and the invention is not to be limited to the details given herein, but may be modified within the scope and equivalence of the appended claims.

1. A method for ejecting liquid in which a droplet of the liquid is ejected onto a liquid seal section encompassed by a seal portion defined on a substrate, the method comprising:
a volume measurement step of measuring the volume of the liquid seal section;
a determination step of determining the ejection amount of the droplet ejected onto the liquid seal section in correspondence with a measurement of the volume; and
an ejection step of ejecting the droplet onto the liquid seal section by the determined ejection amount.

2. The method according to claim 1, wherein, in the volume measurement step, at least one of the width and the height of the seal portion is measured.

3. The method according to claim 1, wherein the determination step includes:
a comparison step of comparing the volume with at least one reference value; and
a selection step of selecting the ejection amount in correspondence with a comparison result obtained from the comparison step.

4. The method according to claim 1, wherein, in the ejection step, the ejection amount is regulated by adjusting the weight of the droplet.

5. The method according to claim 1, wherein, in the ejection step, the ejection amount is regulated by adjusting the number of ejection cycles of the droplet.

6. A liquid ejection apparatus that ejects a droplet of liquid onto a liquid seal section encompassed by a seal portion defined on a substrate, the apparatus comprising:
a volume measurement portion that measures the volume of the liquid seal section;
a determinating portion that determines the ejection amount of the droplet ejected onto the liquid seal section in correspondence with a measurement of the volume; and
an ejecting portion that ejects the droplet onto the liquid seal section by the determined ejection amount 7.

7. The apparatus according to claim 6, wherein the volume measurement portion includes a sensor that measures the volume of the liquid seal section.

8. A method for manufacturing an electro-optic panel by ejecting a droplet of liquid formed of an optical material to a substrate, the method comprising:
a seal portion formation step of defining a seal portion on the substrate for forming a liquid seal section encompassed by the seal portion;
a volume measurement step of measuring the volume of the liquid seal section;
a determination step of determining the ejection amount of the droplet ejected onto the liquid seal section in correspondence with a measurement of the volume; and
an ejection step of ejecting the droplet onto the liquid seal section by the ejection amount.
